(19) United States
(12) Patent Application Publication
(10) Pub. No.: US 2016/0151738 A1
(43) Pub. Date: Jun. 2, 2016

(54) CROSS-LINKED POLYIMIDE GAS SEPARATION MEMBRANE, METHOD OF MANUFACTURING THE SAME, AND USE OF THE SAME

(71) Applicant: L'Air Liquide, Societe Anonyme pour l'Etude et l'Exploitation des Procedes Georges Claude, Paris (FR)

(72) Inventors: Sudhir S. KULKARNI, Wilmington, DE (US); Madhava R. Kosuri, Newark, DE (US); Edgar S. Sanders, Newark, DE (US)

(21) Appl. No.: 14/725,963

(22) Filed: May 29, 2015

Related U.S. Application Data
(60) Provisional application No. 62/085,622, filed on Nov. 30, 2014.

(51) Int. Cl. B01D 53/22; B01D 71/64; B01D 67/00; C08G 73/10

(52) U.S. Cl. CPC B01D 53/228; C08G 73/1007; B01D 71/64; B01D 67/0006

(57) ABSTRACT

A membrane having a polyimide-containing separation layer in which —OH groups on a backbone of the polyimide are cross-linked with a cross-linking agent to form urethane linkages between the adjacent chains.

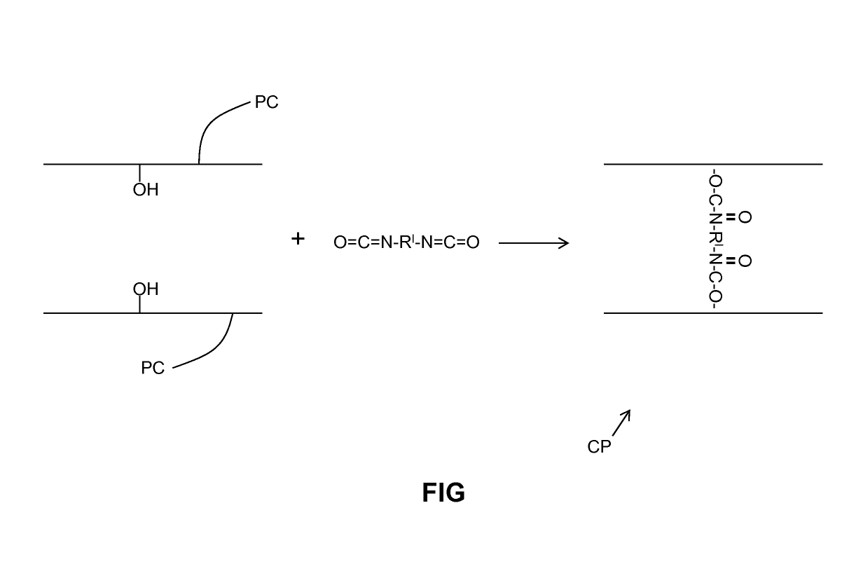

### CROSS-REFERENCE TO RELATED APPLICATIONS

This application claims the benefit of priority under 35 U.S.C. §119 (e) to U.S. Provisional Patent Application No. 62/085,622, filed Nov. 30, 2014, the entire contents of which are incorporated herein by reference.

### BACKGROUND

1. Field of the Invention

The present invention relates to gas separation membranes.

2. Related Art

Polymeric membranes are preferred for gas and liquid separations because they are inexpensive, consume less energy and have less moving parts. Out of different polymers, polyimides are widely studied for gas separation applications because they have good separation characteristics and are relatively more robust in that they exhibit good mechanical strength and are tolerant to different contaminants. However, for aggressive conditions where high concentrations of acid gases such as CO₂ and H₂S are involved, the polyimide membranes get plasticized and their performance degrades. This is typically encountered in natural gas purification.

Therefore, there exists a need for polymers that can efficiently work under those aggressive conditions.

In an effort to provide polymides that exhibit no or at least decreased plasticization from high concentrations of acid gases, several researchers have proposed different methods of crosslinking polyimide membranes.

U.S. Pat. No. 7,247,191 B2 discloses the crosslinking of polyimide membranes via a transesterification reaction carried out at 150° C. for 2 hrs in vacuum. The drawback of this process is that the fibers are heated to high temperatures where the substructure collapses, thereby forming a dense skin layer.

Kita et al. have investigated UV induced crosslinking of benzophenone-containing polyimides (Kita et al., Journal of Membrane Science. 87:139-47 (1994)). The challenge with this particular technique is that crosslinking occurs only on the outer skin of the membrane, whereas the rest of the membrane remains un-crosslinked. This makes it susceptible to plasticization. Moreover, prolonged exposure times results in breakdown of polymer chains.

Chung et al. have studied the use of diamines to crosslink polyimides (Chung et al., Chemical cross-linking modification of 6FDA-2,6-DAT hollow fiber membranes for natural gas separation, Journal of Membrane Science. 216: 257-268 (2003)). Diamines will react with the polyimide membrane by opening up the imide ring and forming an intermolecular amide bond, thereby resulting in a crosslinked polyimide. The drawback of this particular technique is that it results in excessive crosslinking of the skin layer as all of the imide groups would participate in the reaction. This results in relatively low flux.

Therefore, there is a need for crosslinked polyimide membranes that do not exhibit substructure collapse, are not as susceptible to plasticization as conventional membranes, whose polymer chains do not break down after prolonged exposure times, and are not excessively crosslinked.

### SUMMARY OF THE INVENTION

There is disclosed a method of manufacturing a crosslinked polyimide membrane that comprises the following steps. A membrane having a polyimide-containing separation layer is formed, the polyimide including —OH groups on a backbone thereof. At least some of the adjacent chains of the polyimide are crosslinked with a crosslinking agent at the —OH groups to form urethane linkages between said adjacent chains. The crosslinking agent is selected from the group consisting of monomeric diisocyanates, monomeric triisocyanates, and polymeric isocyanates.

### DESCRIPTION OF PREFERRED EMBODIMENTS

The susceptibility to plasticization of membranes having polyimide-containing separation layers may be reduced by cross-linking. The backbone of the polyimide, before cross-linking, includes —OH groups. Adjacent chains of the polyimide may be cross-linked to one another via urethane linkages at the —OH groups by using a cross-linking agent selected from the group consisting of monomeric diisocyanates, monomeric triisocyanates, and polymeric isocyanates.

Examples of suitable polyimide include those comprising alternating units of diamine-derived units and of dianhydride-derived units having the structure of formula I,

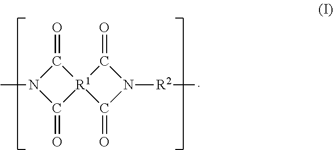

Each R¹ is a molecular segment independently selected from the group consisting of formula (A), formula (B), formula (C), and formula (D):

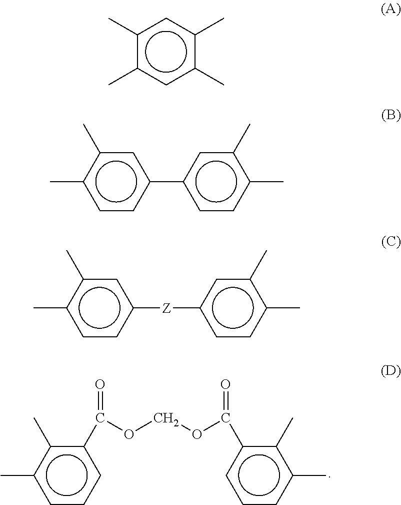

By independently selected, we mean that each R¹ need not be the same, however, typically it is. Z is a molecular segment independently selected from the group consisting of formula (e), formula (f), formula (g), (h), (i), (j), and (k):

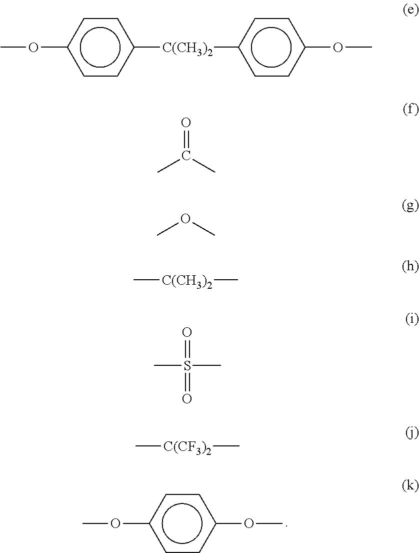

By independently selected, we mean that each Z need not be the same, however, typically it is. R² is a molecular segment derived from a diamine.

10-100% of the R²'s are hydroxyl group-substituted diamine-derived units and are molecular segments independently selected from the group consisting of formula (1), formula (2), formula (3), formula (4), formula (5), formula (6), formula (7), formula (8), formula (9), formula (10), and formula (11):

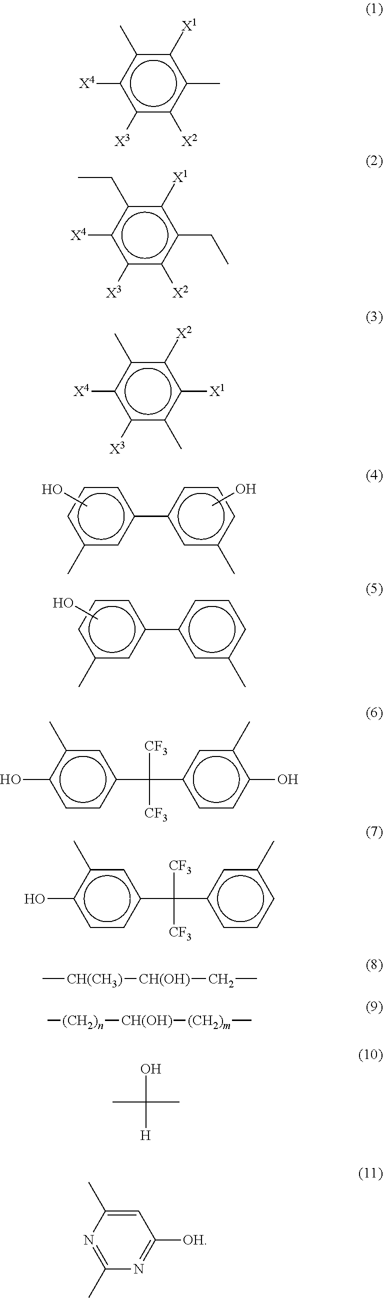

By independently selected, we mean that, for the 10-100% of the R²'s selected from formulae (1)-(11), each of those R²'s need not be the same, however, typically they are. Each of X¹, X², X³, and X⁴ is either H, —CH₃, —CH₂OH, or —OH. At least one of X¹, X², X³, and X⁴ is either —CH₂OH or —OH. Subscript n is an integer ranging from 1-3. Subscript m is an integer ranging from 1-3. The sum of subscripts m and n is no greater than 4.

0-90% of the R²'s are molecular segments independently selected from the group consisting of formula (i), formula (ii), formula (iii), formula (iv), formula (v), formula (vi), formula (vii), formula (viii), formula (ix), formula (x), formula (xi), formula (xii), formula (xiii), formula (xiv), formula (xv), and formula (xvi):

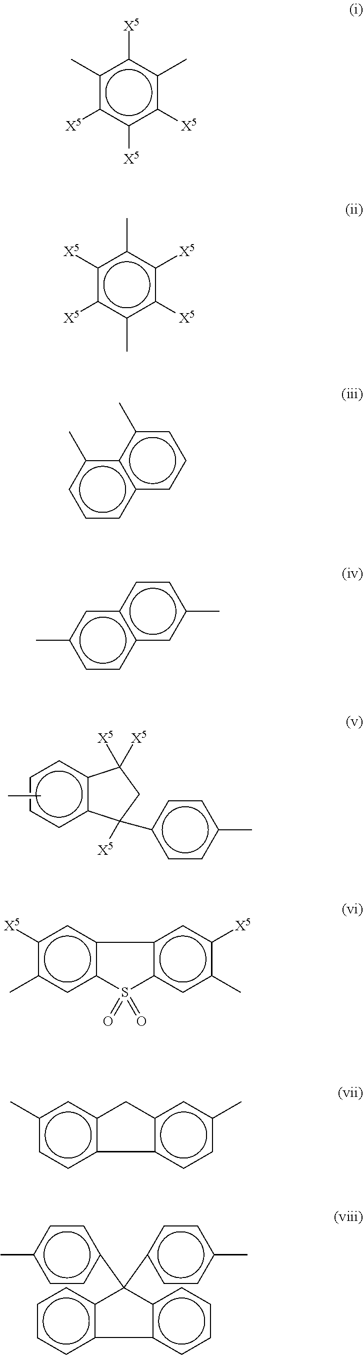

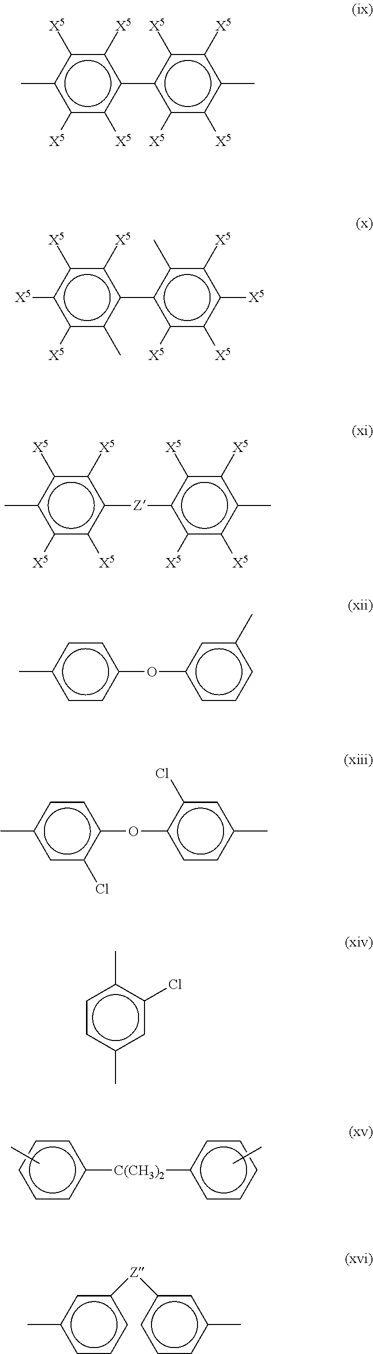

By independently selected, we mean that, for the 0-90% of the R²'s selected from groups (i)-(xvi), each of those R²'s need not be the same, however, typically they are. Each X⁵ is independently selected from the group consisting of hydrogen, —Cl, —OCH₃, —OCH₂CH₃, and a straight or branched C₁ to C₆ alkyl group. By independently selected, we mean that each diamine-derived unit that is not hydroxyl group-substituted need not be the same in each case but typically they are. Similarly, each of the X⁵ need not be the same but typically they are.

Each Z′ is a molecular segment independently selected from the group consisting of the molecular segment of formula (xvii), formula (xviii), formula (xix), formula (xx), formula (xxi), formula (xxii), formula (xxiii), formula (xxiv), formula (xxv), formula (xxvi), formula (xxvii), formula (xxviii), formula (xxix), formula (xxxi), formula (xxxii), formula (xxxiii), formula (xxxiv), formula (xxxv), formula (xxxvi), formula (xxxvii), formula (xxxviii), formula (xxxix), and formula (xl):

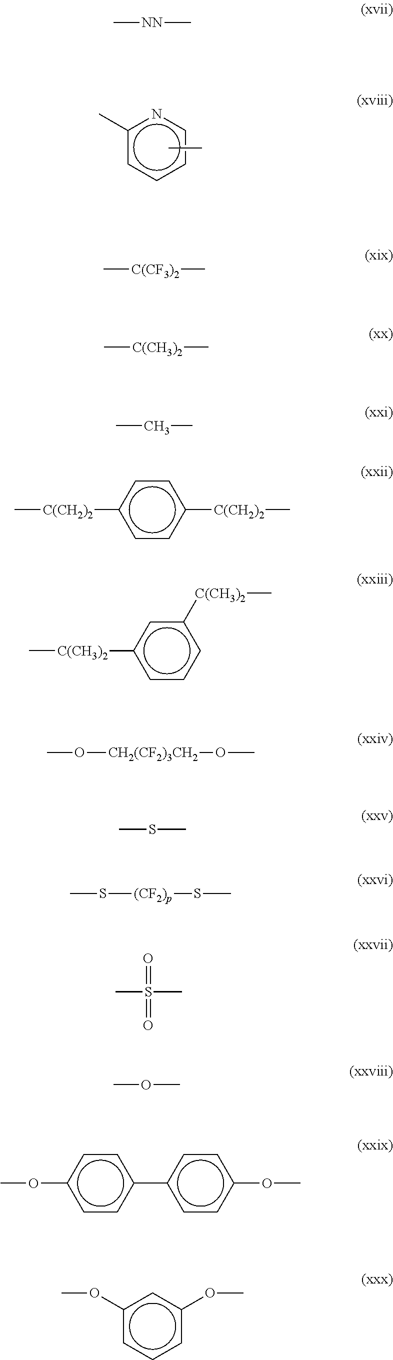

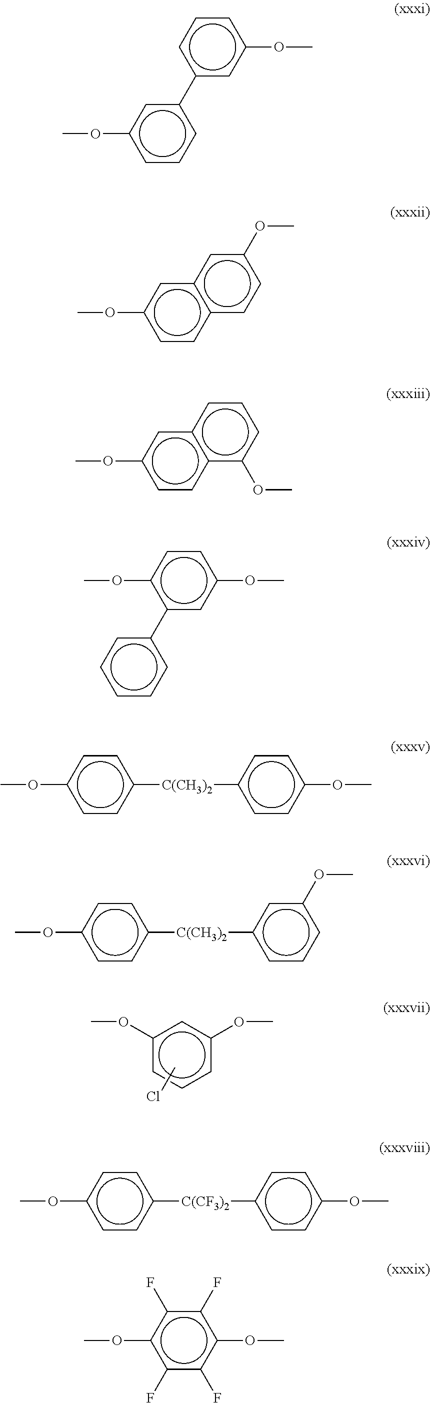

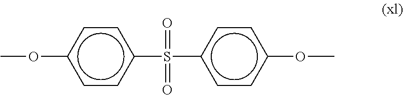

Subscript p is an integer from 1-10. Each Z″ is a molecular segment independently selected from the group consisting of the molecular segment of formula (xxvii), formula (xxviii), and formula (xl). By independently selected, we mean that each Z′ not need be the same but they typically are and each Z″ need not be the same but they typically are.

In one particular embodiment, R¹ is the molecular segment of formula (C) and Z is the molecular segment of formula (j).

In another particular embodiment, R² is the molecular segment of formula (1) or formula (3), one of X¹, X², X³, and X⁴ is —OH while the others of X¹, X², X³, and X⁴ are —H.

In another particular embodiment, R² is the molecular segment of formula (4).

In another particular embodiment, R² is the molecular segment of formula (10).

In another particular embodiment, R² is the molecular segment of formula (11).

The uncrosslinked polyimide may be synthesized by reacting, in any one of a wide variety of known polyimide synthesis methods, stoichiometric amounts of one or more dianhydrides and one or more hydroxyl group-substituted diamines to form the intermediate poly(amic acid) followed by removal of water to form the polyimide by ring-closing. The skilled artisan will understand that a stoichiometric amount of a dianhydride reacted with a stoichiometric amount of a mixture of diamines will result in a random copolymer. Alternatively, a block copolymer of the dianhydride and one or more hydroxyl group-substituted diamines may be synthesized according to known methods in which case the hydroxyl group-substituted diamines are not initially in admixture. The skilled artisan will similarly understand that a stoichiometric amount of a mixture of dianhydrides reacted with a stoichiometric amount of a hydroxyl group-substituted diamine will also form a random copolymer and that a block copolymer may alternatively be synthesized according to known methods in which case the dianhydrides are not initially in admixture. Finally, the skilled artisan will further understand that a stoichiometric amount of a mixture of dianhydrides reacted with a stoichiometric amount of a mixture of hydroxyl group-substituted diamines will result in a random polymer and that a block copolymer may alternatively be synthesized according to known methods in which case the dianhydrides are not initially in admixture and the hydroxyl group-substituted diamines are not initially in admixture. The skilled artisan will recognize that, for crosslinked polyimides where less than 100% of the R²'s are the molecular segments selected from formulae (1)-(11), the uncrosslinked polyimide may be synthesized by reacting stoichiometric amounts of one or more dianhydrides and one or more hydroxyl group-substituted diamines and one or more non-hydroxyl group-substituted diamines to form the intermediate poly(amic acid) followed by removal of water to form the polyimide by ring-closing.

Suitable dianhydrides are represented by formula (I′), where R¹ is as described above.

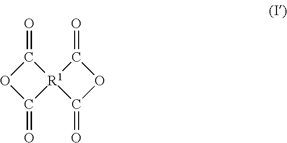

One particular dianhydride is 2,2′-bis(3,4-dicarboxyphenyl hexafluoropropane) which conventionally termed 6FDA. Other particular dianhydrides include: 4,4′-biphthalic dianhydride (BPDA), benzophenone-3,3′,4,4′-tetracarboxylic dianhydride (BTDA), pyromellitic dianhydride (PMDA), 1,2,3,4-butanetetracarboxylic dianhydride (BTCDA).

Suitable diamines for the 10-100% portion of the R's are hydroxyl-substituted diamines selected from the group consisting of formula (1), formula (2), formula (3), formula (4), formula (5), formula (6), formula (7), formula (8), formula (9), formula (10), and formula (11):

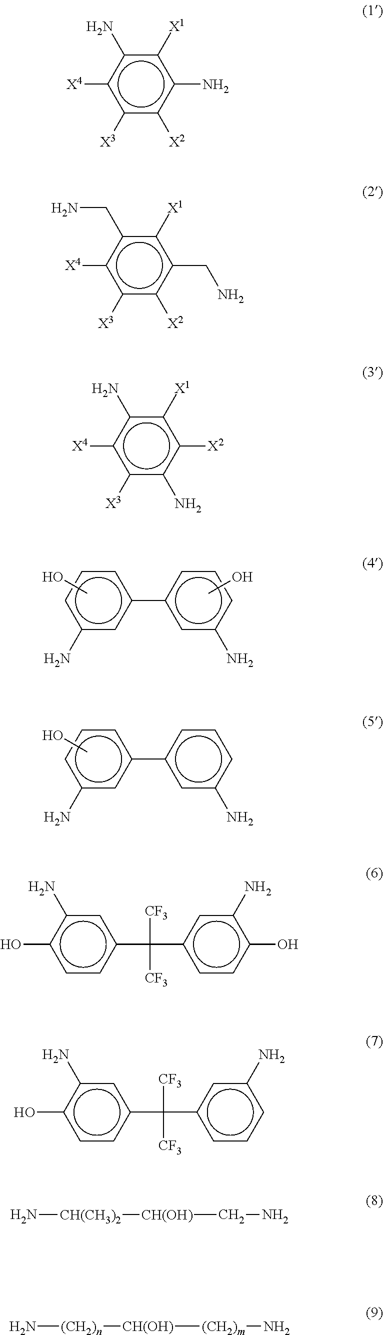

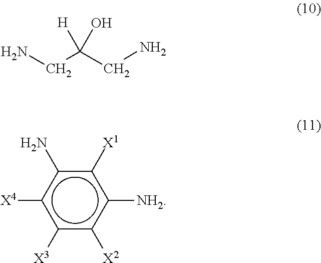

X¹, X², X³, X⁴, n, and m are as described above. Exemplary hydroxyl-substituted diamines include but are not limited to: diaminophenol, diamino hydroxypyrimidine, diamino propanol, diamino hydroxy butanol, and diamino hydroxylpentanol.

The structures of the diamines corresponding to the 90-0% portion of the R²'s can be easily deduced by replacing each open bond of formulae (i)-(xvi) with an amine group (—NH₂) where each X⁵, Z′, p and Z″ is as described above.

For the cross-linking agent, typical monomeric diisocyanates include toluene diisocyanate (TDI), hexamethylene diisocyanate (HDI), naphthalene diisocyanate (ND), phenylene diisocyanate, isopharone diisocyanate (IPDI), and methylene diphenylmethane diisocyanate (MDI). Typical monomeric triisocyanates include: triphenylmethane-4,4′,4″-thisocyanate (TTI); toluene-2,4,6-triyl triisocyanate; and 2,4,6-trimethyl-benzene-1,3,5-triyl triisocyanate. Typical polymeric isocyanates include poly methylene diphenylmethane diisocyanate (PMDI) and poly hexamethylene diisocyanate (PHDI). The FIG illustrates the crosslinking reaction when the crosslinking agent is a diisocyanate. Each isocyanate group reacts with a hydroxyl group on different chains PC of the polymer to form a urethane linkage between the two chains to form the crosslinked polymer CP. Based upon this reaction, those skilled in the art will readily understand that adjacent polymer chains (substituted with hydroxyl groups) may be crosslinked in a corresponding way by a crosslinking agent that is a triisocyanate or a polyisocyanate.

Regardless of which crosslinking agent is used, the degree of crosslinking may be controlled by appropriate adjustment of the ratio of the hydroxyl group-substituted diamine to the non-hydroxyl group-substituted diamine. For example, a more completely crosslinked polymer will be polymerized from little to none of the non-hydroxyl group-substituted diamine while one exhibiting little crosslinking will be polymerized from a diamine mixture containing as much as 90% of the non-hydroxyl group-substituted diamine.

The crosslinking agent may be dissolved in a suitable solvent and provided to the membrane as early as right after drying of the membrane to remove residual solvent or as late as after formation of the gas separation membrane bundle. The individual membranes or the formed gas separation membrane bundle (in the case of a formed structure containing a plurality of membranes) may be provided with the crosslinking agent by dunking or coating.

While the membrane may have any configuration known in the field of gas separation such as flat or spirally wound sheets, typically it is formed as a plurality of hollow fibers. Methods of making these types of membranes are well known in the art and their details need not be replicated herein. In one embodiment, the hollow fibers have a composite structure including a core surrounding by a sheath where the sheath comprises the above-described crosslinked polyimide and the core comprises any polymer known in the art of gas separation membranes to have suitably high flux, including but not limited to, polyimides, polysulfones, polyamides, polycarbonates, cellulose acetate, polyolefins, polyethers, polyesters, ether-olefin copolymers, ether-ether copolymers, ether-urethane copolymers, and copolyimides.

While there is a wide variety of feed gases that may be usefully separated by the inventive crosslinked membrane, two particular examples include natural gas comprising methane, H₂S and CO₂. and a refinery or petrochemical stream comprising H₂, CO and CH₄. Regardless of the particular gas mixture fed to the membrane, one of ordinary skill in the art will recognize that a permeate gas is withdrawn from “one side” of the membrane that is enriched in a “fast” gas and a non-permeate (aka residue or retentate) gas is withdrawn from “an opposite side” of the membrane that is deficient in the “fast” gas. The “fast” gas is a gas in the feed gas that permeates more easily through the membrane in comparison to “slow” gases in the feed gas. Also, in embodiments where a plurality of membranes are bundled to form a gas separation membrane bundle, “one side” of the membrane is taken as meaning the sides of the membranes opposite the side from which the feed gas is fed.

The invention provides several advantages.

In comparison to non-crosslinked membranes, crosslinked membranes are expected to exhibit good permeability, selectivity, and resistance to plasticization.

The invention also provides advantages over to known methods of crosslinking membranes.

The crosslinking reaction of the invention may be carried out at significantly lower temperatures in comparison to conventional membrane crosslinking techniques. For example, the crosslinking reaction of the invention may be carried out at temperatures of 80-120° C. The crosslinking may then be carried out in tandem with drying of the manufactured fiber or bundle. In contrast, the crosslinking reaction of U.S. Pat. No. 7,247,191 B2 is 150° C. for a 24 hour duration. Because significantly lower temperatures are required in practice of the invention, it is far less complex to raise and maintain the temperature of the membrane to the range at which crosslinking occurs. In commercial scale manufacturing, raising the temperature of the membrane to far higher temperatures is a non-trivial task.

The crosslinking sites (hydroxyl functional groups) of the invention are far less reactive than the crosslinking sites (carboxylic acid functional groups) of U.S. Pat. No. 7,247,191 B2. Because the crosslinking sites are far less reactive, they are far less prone to crosslinking at manufacturing/processing steps prior to the intended time at which crosslinking is desired. For example, the mere drying, at elevated temperatures, of the polymer of U.S. Pat. No. 7,247,191 B2 prior to its dissolution in the spin dope solution may cause that polymer to prematurely crosslink. When one attempts to dissolve such a prematurely crosslinked polymer in a spin dope solution solvent, a gel may be formed. The presence of gels significantly impacts the processability of the polymer during the fiber spinning process. Therefore, it is far more difficult to produce uniform fibers without process upsets.

The crosslinking reaction of the invention is far less complex than that of Chung et al. Chung et al. propose a crosslinking reacting in which p-xylenediamine opens up the imide ring of the 6FDA monomeric units of the 6FDA/durene polymer to form an amide linkage. Because the structure of the non-crosslinked polymer is significantly changed (i.e., it undergoes ring-opening), we believe that the performance of membranes resulting from such a crosslinking reaction would relatively difficult to predict when such a crosslinking reaction is applied to polymers other than 6FDA/durene.

The crosslinking reaction of the invention allows a far higher degree of crosslinking of the membrane in comparison to Kita et al. Because Kita et al.

proposes crosslinking by uv irradiation, only outer portions of the membrane may be crosslinked because the uv light does not penetrate deeply into the membrane. In comparison, the crosslinking reaction of the invention is not carried out by irradiation and therefore the entire extent of the membrane can theoretically be crosslinked. This allows the membrane to be provided with extra robustness and resistance to plasticization that membranes produced by the Kita et al. method would likely not possess.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method of manufacturing a crosslinked polyimide membrane, comprising the steps of:
forming a membrane having a polyimide-containing separation layer, the polyimide including —OH groups on a backbone thereof; and
crosslinking at least some of the adjacent chains of the polyimide with a crosslinking agent at the —OH groups to form urethane linkages between said adjacent chains, the crosslinking agent being selected from the group consisting of monomeric diisocyanates, monomeric triisocyanates, and polymeric isocyanates.

2. The method of claim 1, wherein:
the polyimide comprises repeating units of the structure of formula I, 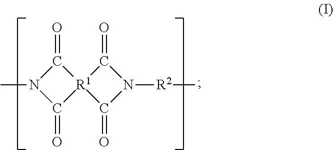
R¹ is a molecular segment independently selected from the group consisting of formula (A), formula (B), formula (C), and formula (D): 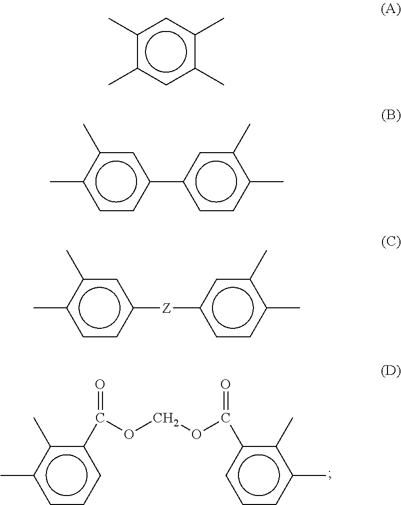
Z is a molecular segment independently selected from the group consisting of formula (e), formula (f), formula (g), (h), (i), (j), and (k): 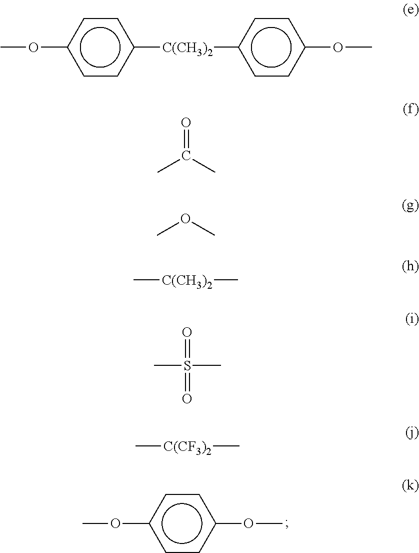
R² is a molecular segment derived from a diamine;
10-100% of the R²'s are hydroxyl group-substituted diamine-derived units and are molecular segments selected from the group consisting of formula (1), formula (2), formula (3), formula (4), formula (5), formula (6), formula (7), formula (8), formula (9), formula (10), and formula (11): 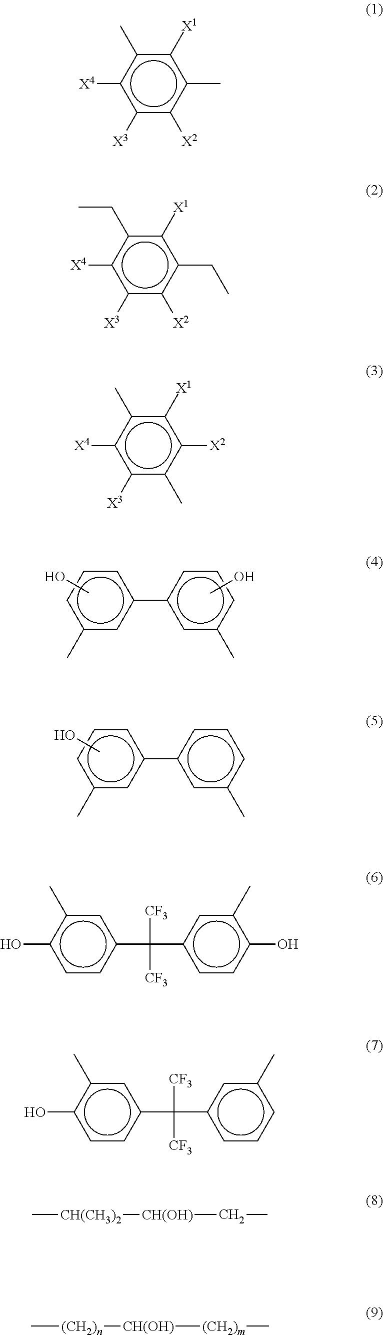 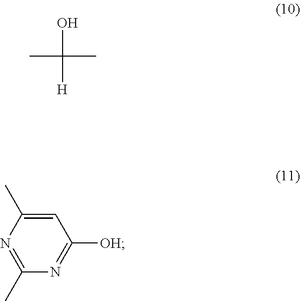
each of X¹, X², X³, and X⁴ is either H, —Cl, —CH₃, —CH₂OH, —CH₂CH₂OH, —CH(CH₃)CH₂OH or —OH;
at least one of X¹, X², X³, and X⁴ is either —CH₂OH, —CH₂CH₂OH, —CH(CH₃)CH₂OH or —OH;
n is an integer ranging from 1-3;
m is an integer ranging from 1-3;
m+n is no greater than 4;
0-90% of the R²'s are molecular segments selected from the group consisting of formula (i), formula (ii), formula (iii), formula (iv), formula (v), formula (vi), formula (vii), formula (viii), formula (ix), formula (x), formula (xi), formula (xii), formula (xiii), formula (xiv), formula (xv), and formula (xvi): 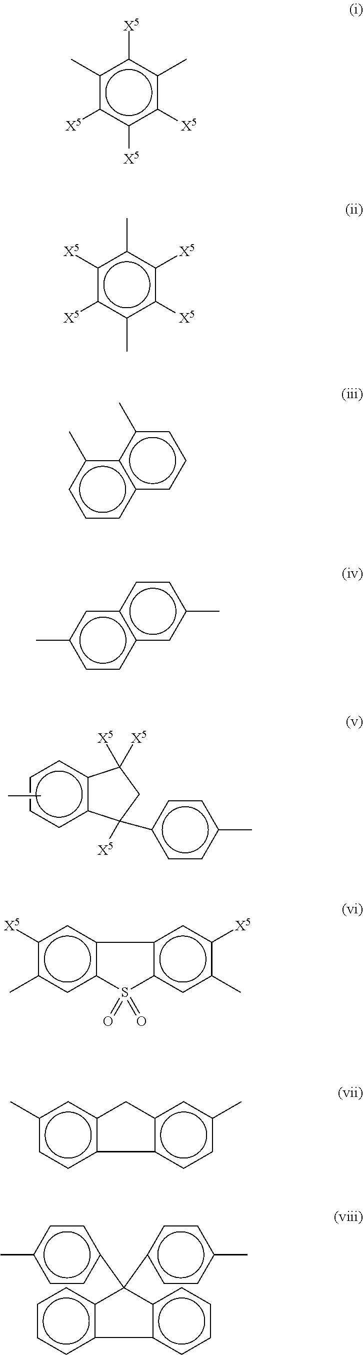 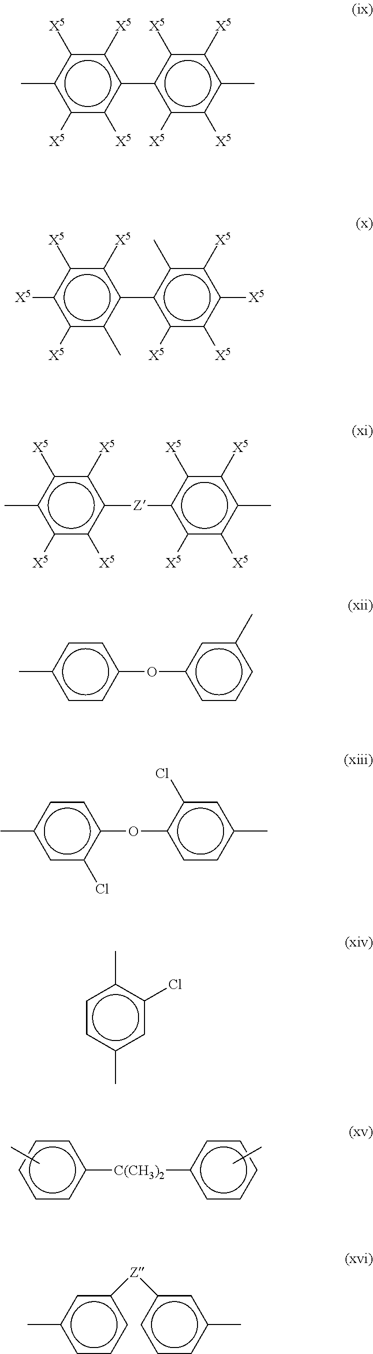
each X⁵ is independently selected from the group consisting of hydrogen, —Cl, —OCH₃, —OCH₂CH₃, and a straight or branched C₁ to C₆ alkyl group; and
each Z′ is a molecular segment independently selected from the group consisting of the molecular segment of formula (xvii), formula (xviii), formula (xix), formula (xx), formula (xxi), formula (xxii), formula (xxiii), formula (xxiv), formula (xxv), formula (xxvi), formula (xxvii), formula (xxviii), formula (xxix), formula (xxxi), formula (xxxii), formula (xxxiii), formula (xxxiv), formula (xxxv), formula (xxxvi), formula (xxxvii), formula (xxxviii), formula (xxxix), and formula (xl): 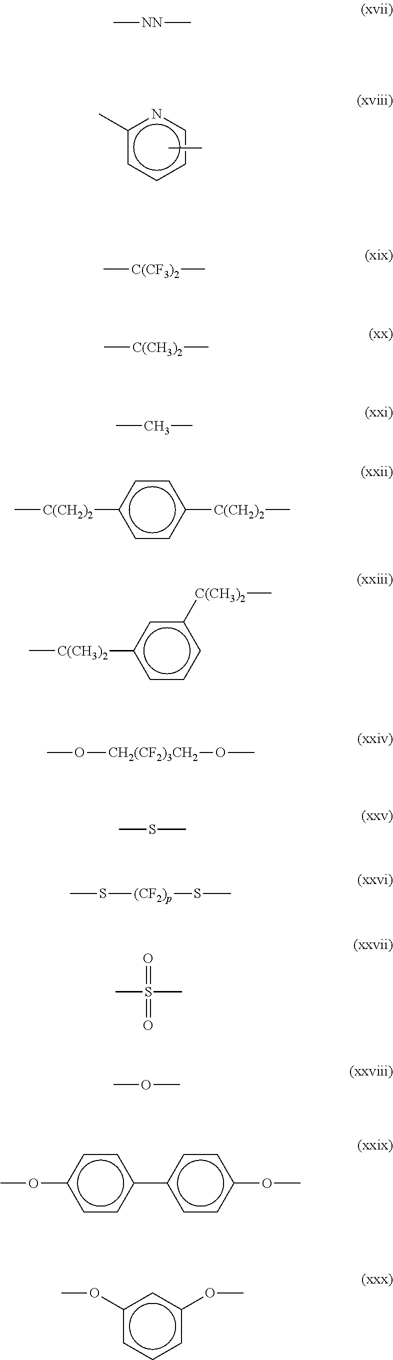 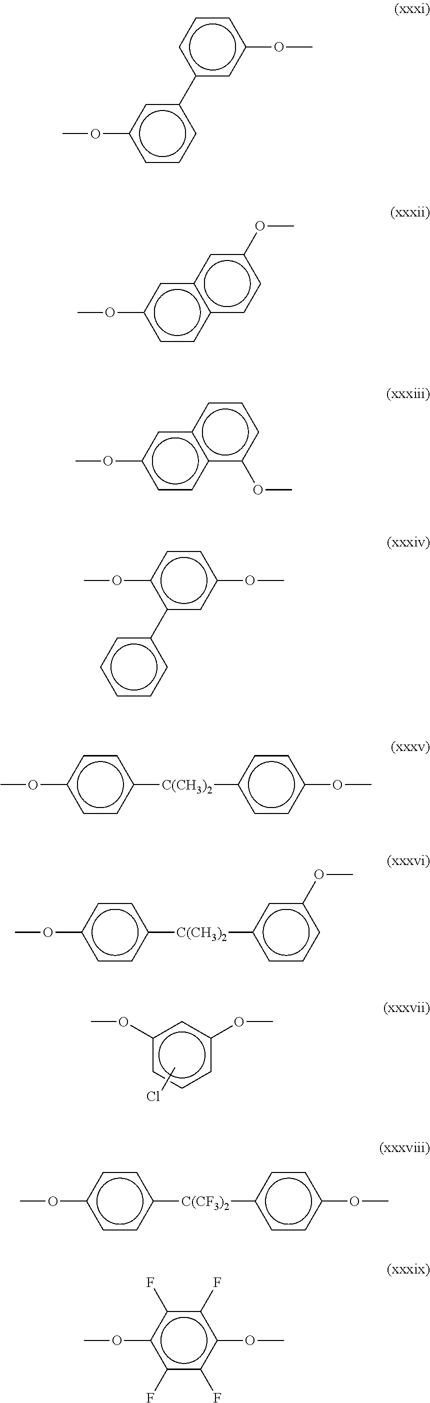 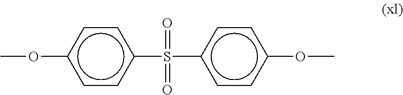
p is an integer from 1-10;
each Z″ is a molecular segment independently selected from the group consisting of the molecular segment of formula (xxvii), formula (xxviii), and formula (xl).

3. The method of claim 2, wherein R¹ is the molecular segment of formula (C).

4. The method of claim 3, wherein Z is the molecular segment of formula (j).

5. The method of claim 2, wherein 10-100% of the R²'s are the molecular segments of formula (1).

6. The method of claim 2, wherein 10-100% of the R²'s are the molecular segments of formula (2).

7. The method of claim 2, wherein 10-100% of the R²'s are the molecular segments of formula (3).

8. The method of claim 2, wherein 10-100% of the R²'s are the molecular segments of formula (4).

9. The method of claim 2, wherein 10-100% of the R²'s are the molecular segments of formula (5).

10. The method of claim 2, wherein 10-100% of the R²'s are the molecular segments of formula (6).

11. The method of claim 2, wherein 10-100% of the R²'s are the molecular segments of formula (7).

12. The method of claim 2, wherein 10-100% of the R²'s are the molecular segments of formula (8).

13. The method of claim 2, wherein 10-100% of the R²'s are the molecular segments of formula (9).

14. The method of claim 2, wherein 10-100% of the R²'s are the molecular segments of formula (10).

15. The method of claim 2, wherein 10-100% of the R²'s are the molecular segments of formula (11).

16. The membrane produced by the method of claim 1.

17. A method of separating gases, comprising the steps of feeding a stream of feed gas comprising a fast gas and a slow gas to the membrane of claim 16, withdrawing permeate and non-permeate streams from the membrane, the permeate stream having a greater concentration of the fast gas than the non-permeate stream, the non-permeate stream having a greater concentration of the slow gas than the permeate stream.

18. The method of claim 17, wherein the feed gas comprises natural gas comprising methane, H₂S and CO₂.

19. The method of claim 17, wherein the feed gas is a refinery or petrochemical stream comprising H₂, CO and CH₄.
